(19) United States
(12) Patent Application Publication
(10) Pub. No.: US 2026/0212109 A1
(43) Pub. Date: Jul. 23, 2026

(54) SOFTWARE FOR EDITING TEXT-BASED DOCUMENTS

(71) Applicant: Scribe Technologies Limited, London (GB)

(72) Inventor: Kevin Prosper David TOUATI, London (GB)

(73) Assignee: Scribe Technologies Limited, London (GB)

(21) Appl. No.: 19/135,310

(22) PCT Filed: Dec. 19, 2023
(86) PCT No.: PCT/GB2023/053309

§ 371 Date: Jun. 3, 2025

(30) Foreign Application Priority Data
Dec. 20, 2022 (GB) 2219313.0

(51) Int. Cl. G06F 40/166; G06F 40/131; G06F 40/157

(52) U.S. Cl. CPC G06F 40/166; G06F 40/131; G06F 40/157

(57) ABSTRACT

A computer-implemented method for editing a text-based document. The method comprises causing content from a text-based document to be displayed on a display device, causing a user interface for editing the document to be provided on the display device, processing an input that identifies a text string in the document as an attribute string and creating an entry for the attribute string in a database. The method further comprises receiving an initial string value to be assigned to the attribute string through the user interface, associating the initial string value with the attribute string in the database and causing content from the document to be displayed on the display device, wherein an instance of the initial string value is displayed in place of an instance of the attribute string in the document.

### BACKGROUND OF THE INVENTION

This invention relates to computer-implemented methods, software and systems for editing text-based documents.

Document editing software is widely used for authoring and editing text-based documents of many different types, including letters, reports, legal documents, books, computer source code, user manuals, etc. Software editors range from simple editors for editing plain-text documents, such as Microsoft™ Windows™ Notepad, through to complex word-processing software such as Microsoft™ Word™ that support layout information, different font types, sizes and colours, embedded images, etc.

Document editors provide a graphical user interface that, at any moment in time, typically displays a portion of a text-based document on screen. The display may uniformly represent the underlying text-based document, or information from the text may be interpreted by the document editor to determine how to display the content; for example, source code editors use syntax highlighting to highlight key words and code structures in different colours in the display, albeit without changing the underlying text-based document (i.e. the data to be saved to a filesystem).

Document editors can also provide editing tools to assist the user in efficiently editing a text-based document. One such tool is a search & replace function that allows instances of a first text string in the document to be replaced with a second text string supplied by the user. Unlike syntax highlighting, such a replacement operation does not merely affect what is transiently displayed to the user but changes the actual text of the document.

While known editing methods are useful, the applicant has identified that further improvements are possible. Embodiments of the present invention thus seek to provide improved editing software and methods.

### SUMMARY OF THE INVENTION

From some aspects, the invention provides a method for editing a text-based document. The method may comprise displaying content from a text-based document on a display device, or causing content from a text-based document to be displayed on a display device. It may comprise providing a user interface for editing the document on the display device, or causing a user interface for editing the document to be provided on the display device.

From other aspects, the invention provides computer software for editing a text-based document which, when executed by a computer system, causes the computer to perform any method disclosed herein.

From further aspects, the invention provides a computer system for editing a text-based document, wherein the computer system is configured to perform any method disclosed herein.

Any combinations of features disclosed herein may be optional features of embodiments of these aspects.

In some embodiments, the method may further comprise processing an input that identifies a text string in the document as an attribute string. It may comprise creating an entry for the attribute string in a database, e.g. in response to processing the input. It may comprise receiving an initial string value to be assigned to the attribute string. It may comprise associating the initial string value with the attribute string in the database. It may comprise displaying an instance of the initial string value in place of an instance of the attribute string in the document when displaying content from the document on the display device, or may comprise causing content from the document to be displayed on the display device wherein an instance of the initial string value is displayed in place of an instance of the attribute string in the document.

Thus, from one aspect, the invention provides a computer-implemented method for editing a text-based document, the method comprising:
causing content from a text-based document to be displayed on a display device;
causing a user interface for editing the document to be provided on the display device;
processing an input that identifies a text string in the document as an attribute string;
creating an entry for the attribute string in a database;
receiving, through the user interface, an initial string value to be assigned to the attribute string;
associating the initial string value with the attribute string in the database; and
causing content from the document to be displayed on the display device, wherein an instance of the initial string value is displayed in place of an instance of the attribute string in the document.
From another aspect, the invention provides computer software for editing a text-based document which, when executed by a computer system, instructs the computer system to:
cause content from a text-based document to be displayed on a display device;
cause a user interface for editing the document to be provided on the display device;
process an input that identifies a text string in the document as an attribute string;
create an entry for the attribute string in a database;
receive, through the user interface, an initial string value to be assigned to the attribute string;
associate the initial string value with the attribute string in the database; and
cause content from the document to be displayed on the display device, wherein an instance of the initial string value is displayed in place of an instance of the attribute string in the document.

From another aspect, the invention provides a computer system for editing a text-based document, wherein the computer system is configured to:
cause content from a text-based document to be displayed on a display device;
cause a user interface for editing the document to be provided on the display device;
process an input that identifies a text string in the document as an attribute string;
create an entry for the attribute string in a database;
receive, through the user interface, an initial string value to be assigned to the attribute string;
associate the initial string value with the attribute string in the database; and
cause content from the document to be displayed on the display device, wherein an instance of the initial string value is displayed in place of an instance of the attribute string in the document.

Thus it will be seen that, in accordance with these aspects, document-editing software can build a database for a text-based document that allows a user to configure what text is displayed at particular positions within the document as the document is displayed on a display device. In particular, the user may identify certain text within the document as attribute strings, and have a user-configurable value displayed wherever that attribute would otherwise appear in the document. The provision of a database enables this to be done without having to change the underlying document. These methods are more powerful than static syntax-highlighting rules and also provide greater flexibility than conventional search & replace functions, because string values can be stored in a database rather than changing the underlying text content of the document itself. This can enable attribute values to be conveniently reconfigured and updated at subsequent points in time.

In some embodiments, the method may further comprise:
receiving, through the user interface, an updated string value to be assigned to the attribute string, wherein the updated string value is different from the initial string value;
associating the updated string value with the attribute string in the database; and
causing content from the document to be displayed on the display device, wherein an instance of the updated string value is displayed in place of an instance of the attribute string in the document.

Thus one or more instances of the initial string value that were initially displayed on the display may be replaced by respective instances of the updated string value, at the same positions within the document.

For example, a user may identify the word “Name” in the document as an attribute string, and provide an initial string value of “Alice”, so as to cause each instance of “Name” in the underlying document will be substituted with “Alice” when the document is displayed. Then, the user may input an updated string value of “Bob”, and each instance of “Name” in the underling document will then be rendered as “Bob” in the displayed content.

Further user inputs may be received that may lead to successive updating of instances of the attribute string with respective new string values. The software may support limitless re-assignment of further string values to the attribute string.

In some embodiments, a respective instance of the initial string value may be displayed in place of each of a plurality of instances of the attribute string in the document, when displaying content from the document on the display device. In some embodiments, a respective instance of the initial string value may be displayed in place of every instance of the attribute string in the document, when displaying content from the document on the display device. In some embodiments, a respective instance of the initial string value may be displayed in place of each of a set of instances of the attribute string in the document that are associated with a same object string in the database (e.g. as described in more detail below).

The database may be configured to store at most one string value in association with the attribute string at any instant. Both the attribute string and the string value may be stored as text data in the database. The initial string value may be replaced (e.g. overwritten) by the updated string value in the database, e.g. in response to receiving a user input of the updated string value. In this way the database may be stored efficiently in a memory of the computer system.

The input that identifies a text string as an attribute string may take any of various forms. It may be received through the user interface, but this is not essential in all embodiments. It may comprise an action taken by the user while the content is being displayed on the display device. The method may comprise receiving the user input, e.g. from a user. However, it may alternatively or additionally comprise data that identifies the text string, which data may have been generated or provided by a user at an earlier time. It may comprise data that is stored within the text content of the document. In some embodiments, the input comprises a predetermined attribute-marker character string. This could be already present in the document when it is opened, but in some embodiments the method may comprise the user introducing (e.g. by typing on a keyboard) a predetermined attribute-marker character string (of one or more characters) to the document adjacent the attribute string. In some embodiments, it may be an opening attribute-marker character string (e.g. the character “#”) positioned immediately before the attribute string (i.e. separated at most by whitespace). The attribute-marker character string may be positioned or introduced before or immediately after the text string is provided in the document. For example, in some embodiments, if the attribute-marker character string is introduced adjacent an existing string, the existing string may thereby be identified as an attribute string.

Alternatively, the attribute-marker character string may, in some embodiments, be introduced into the document before the text string is present in the document, e.g. with a user inputting (e.g. typing) the attribute-marker character string through the user interface, followed by inputting (e.g. typing) a new string to be identified as an attribute string. For example, the user may introduce (e.g. type on a keyboard) the characters “#Name ” in sequence into the document, thereby causing an attribute string to be identified for the new string “Name”.

In some embodiments, the input that identifies a text string as an attribute string may additionally or alternatively comprise a terminal attribute-marker character string (e.g. the string “of”) immediately after the attribute string. This may be received as an input from the user (e.g. being typed), or may already be present in the document when the method steps are performed. The use of both opening and terminal attribute-marker characters may enable support for multi-word attribute strings. However, in some embodiments, the attribute string is always only a single word (e.g. “Name”). It may be demarcated by whitespace or punctuation at the opposite end of the attribute string to a predetermined attribute-marker character string (e.g. as in “#Name ”). The input may comprise receiving the predetermined attribute-marker character string or strings as input from a text entry device such as a physical or touchscreen keyboard.

Including the attribute-marker characters as text within the text of the document itself (rather than, for example, recording the attribute string in metadata outside the textual content of the document), can provide for an intuitive and straightforward implementation, e.g. allowing users viewing the underlying text of the document to see easily if and where any attribute strings are present in the document.

The initial string value may be received as a user input. It may be received into a text input interface (e.g. a pop-up box), wherein the text input interface is displayed on the display device in response to a user interaction. The user interaction may be an interaction with an instance of the attribute string or with an instance of an object string in the displayed content—e.g. in response to the user tapping or clicking on the instance.

The string value may be processed and/or stored as a text string, but this is not necessarily always the case. In some embodiments, a string value may represent a number or other data type. In some embodiments, the software may comprise instructions for processing a string value as any one or more of: a date, a time, an integer value, a decimal value, a monetary value, a location, or any other data type. It may detect a data type of the string value automatically, or the user interface may provide a mechanism for receiving data type information for a string value.

The software may comprise instructions for creating and/or for managing the database. The database may be able to store a plurality of entries each associated with a different respective user-identified attribute string.

In some embodiments, one or more attribute strings may be associated with an object string in the database. The software may create such associations in response to user inputs. In some embodiments, each attribute may be required to be associated with a respective object, while in other embodiments the creation of such associations may be optional, may not be supported at all. (For simplicity, an attribute string may also be referred to herein as an attribute; object string may be referred to as an object; and a string value may be referred to as a value or attribute value.) Enabling attributes to be associated with objects in the database can enable more convenient editing of values by grouping multiple attributes together. It may also enable the same attribute string to have different roles within the same document, by having some instances associated with a first object and other instances associated with a second object (e.g. some instances of “Name” may be an attribute of “Employer”, while others may be an attribute of “Employee”).

Thus, the method may comprise processing an input that identifies a text string in the document as an object string. The identification may be used to create an entry for the object string in the database, e.g. if an entry does not already exist.

The input that identifies a text string as an object string may comprise a predetermined opening object-marker character string (e.g. the word “of”, or a phrase of the form “# xx of” where “xx” can be any word or phrase) immediately before the object string (i.e. separated at most by whitespace). In some embodiments, it may additionally or alternatively comprise a terminal object-marker character string immediately after the object string. It may comprise the user introducing (e.g. by typing on a keyboard) one or both of these, or one or both may be already present in the document. The use of both opening and terminal object-marker characters may enable support for multi-word object strings. However, in some embodiments, the object string is always only a single word (e.g. “employer”). It may be demarcated by whitespace or punctuation at the opposite end of the attribute string to a predetermined attribute-marker character string (e.g. as in “# name of employer”). The input may comprise receiving the predetermined object-marker character string or strings as input from a text entry device such as a physical or touchscreen keyboard.

The database may be configured for associating a number of attributes (e.g. zero, one or more attributes) with each object in the database. This can enable convenient editing of respective string values assigned to the attribute strings of a selected object string, e.g. by displaying all of the assigned string values for a particular object together in a same interface element (e.g. in the same pop-up box).

In some embodiments, a user can create an association between two or more objects in the database. One or more attributes associated with a first object may be associated with a second object following establishment of an association to the first object. The database may be able to store class definitions (i.e. identifying a type of object). The database may identify two or more objects as belonging to (i.e. instantiating) the same class. In one example, an “employer” object and a “contractor” object may both be identified in the database as belonging to the class “company”. In another example, a first object, “Employee”, may have “Salary” and “Role” attributes, and a second object or class, “Person”, may have attributes “Name” and “Age” attributes. If the user establishes an association between these two, by defining that an “Employee” is a “Person”, then all of the attributes associated with the “Person” object or class may also become attributes of the “Employee” object also. The values of these new attributes for the “Employee” object may initially be set to null values, and the user may then set them to any desired values.

In some embodiments, a user can create a relational link between two or more attributes or objects in the database, which need not be associated with a common class of object. Such a relational link may cause the value of a first attribute (e.g. of a first object) to depend at least partly on the value of a second attribute (e.g. of a second object, different from the first object). The relational link may comprise an arithmetic or logical expression, which may define one attribute value as a function or more other attribute values. For example, one attribute may be defined by a user to have a value that is the sum of the values of two other attributes belonging to different objects, or to have a value that is a constant value times the value of a second attribute. In this way, attributes may be updated based on user interactions with other attributes. The attributes may be associated with the same object, but this is not required, and attributes of multiple objects may interact to influence each other in some embodiments.

In some embodiments, a text input interface may be made to appear on the display device in response to a user interaction with an instance of an object string in the displayed content of the document—e.g. in response to the user tapping or clicking on an instance of an object string in the displayed content (not necessarily the same instance that was used for creating the database entry). The text input interface may overlie part of the displayed content. It may appear in proximity of the selected instance. The text input interface may be configured to receive a number of string values equal to at least a number of attribute strings that are associated with the object string in the database. For example, if the attributes “Name” and “Address” are both associated with the object “Employer” in the database, then clicking on the word “Employer” in the phrase “#Name of Employer” or anywhere else in the displayed context may cause a pop-up box to appear with prompts the user to provide or edit string values for each of the “Name” and “Address” attributes.

Providing or editing string values of attributes associated with an object may comprise the user selecting an existing attribute string and subsequently interacting with (e.g. tapping or clicking on) an existing string in the document, causing the value of the attribute string to be set based on the string with which the user interacted. In some embodiments, the string value of the attribute string may be set based on the user interacting with another data structure, e.g. a table or a date in a calendar, after selecting the attribute string. The data structure may be present within the text-based document, or may be stored in a separate document. For example, a user may select the attribute string “Date of Birth”, e.g. by highlighting with a mouse, and subsequently click an area of a calendar corresponding to the date 14 May 1985, causing the string value of the attribute string “Date of Birth” to be set as “14 May 1985”.

The text input interface may, in some embodiments, provide an interface for defining a new attribute string to be associated with the object string. A user may input a new attribute string into the interface (e.g. by typing on a keyboard), and, in response, a new entry for the attribute string may be created in the database, in association with the object string.

A string value (e.g. the initial string value) or an entry for an attribute string in the database may be associated with a scope parameter in the database. The scope parameter may determine whether the string value is displayed in place of a single instance of the attribute string, or every instance of the attribute string in the document. In some embodiments, a plurality of documents may be grouped in a same project and/or in a same folder. The document may be associated with a current project and/or a current folder. The scope parameter may determine whether the string value is displayed in place of every instance of the attribute string just in the document, or in place of every instance of the attribute string in every text-based document in the current project and/or current folder.

The scope parameter may be set in accordance with a user input. It may be received as an input to the text input interface that is displayed in response to a user interaction with an instance of an object string. It may be received as a selection from a list of scope options (e.g. the current instance, the whole document, the current folder, or the current project).

Any method as disclosed herein may be performed using a computer system. It may be performed using computer software stored in a memory of the computer system.

The software may be executed by a processing system of the computer system. In some embodiments, the method may be performed by a single computer, such as a desktop PC, laptop computer, smart phone, tablet, or a server, e.g. running software stored in a memory of the computer. The display device may be a display of the computer—e.g. a screen of a tablet or laptop, or a monitor. However, in other embodiments, the method may be performed by a distributed computer system—e.g. using a server and a client device which may be remote from the server. Thus a computer system as disclosed herein may be a distributed computer system. In some embodiments, the display device, a processing system, and a memory storing computer software for executing by the processing system, may be distributed, e.g. with at least a part of the display device, the memory and the processing system being in different locations. The display device may be remote from the processing system and/or the memory in some embodiments. The display device may be a client device which may be personal computing device, such as a phone, tablet, laptop or PC. The software may be executed on a server, or partly on a server and partly on a client device (e.g. a web-browser or smartphone app). The text-based document may be stored on a memory of the server, or on a memory of a client device, or both. The server may cause content from the text-based document and/or the user interface for editing the text-based document to be displayed on a display device by sending instructions to the display device over a network connection, e.g. over the Internet.

In some embodiments, a memory storing computer software as disclosed herein and/or storing the text-based document may comprise a local memory of the computer system, and/or may comprise a memory provided at a remote (e.g. cloud-based) server, e.g. accessed over a network. In some embodiments, the memory may comprise a combination of a local memory and remote memory. In such embodiments, one or more changes made to the local memory may be reproduced in the cloud-based memory, and/or vice versa—e.g. when the text-based document is saved. The system may thus synchronize local and remote versions of the text-based document.

The user interface may be provided using an operating system and/or a web browser and/or another software application (e.g. a dedicated Android or iOS app), which may be executing on the computing system. It may be arranged to display text and to receive text input. It may display graphical icons and other user interface elements.

The memory may comprise a volatile memory (e.g. RAM) and/or a non-volatile memory (e.g. flash memory or a magnetic storage device). In use, the document may be stored in a volatile memory while being edited. The method may comprise saving the document to a non-volatile memory as a file. The document may be stored as a file in a folder (e.g. the current folder mentioned above), optionally with one or more further text-based documents. The user may edit the text document using the interface for editing the document. Such editing may change the document in the volatile memory. It may change the document file when the document is next saved. However, string values received from the user are stored in the database and, at least in some embodiments, do not change the text content of the document. The database may be stored in a same file with the text-based document. The text of the document may be stored as an entry in the database, or the text-based document and database may be separate entities, e.g. within a single file.

The text-based document may be a plain-text document, or it may store layout or typography information. It may contain only text content, or it may also contain multimedia content such as embedded images. It be stored as a plain-text file (e.g. a Microsoft Windows™.txt file) or it may be an XML file, or a Microsoft Office™.docx file, or any other type of document or file format.

The software may implement version control for the document and/or for a project comprising multiple documents. It may support different user access settings for different versions or branches.

User inputs may be received by a same user or by different respective users.

The software disclosed herein may be stored on a non-transitory computer-readable storage medium such as a solid-state memory or an optical or magnetic storage device.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain embodiments of the invention will now be described, by way of example only, with reference to the accompanying drawings, in which:

FIG. 1 is a schematic diagram of a computer system for editing text-based documents that embodies the invention;

FIG. 2 is a mock-up of a user interface generated by the computer system;

FIG. 3 is a schematic representation of attribute strings and a database configured to store attribute strings and associated values;

FIG. 4 is a process flow diagram illustrating steps of a method embodying the invention;

FIG. 5 is a process flow diagram illustrating optional further steps of the method;

FIG. 6 is a mock-up of a user interface generated by the computer system;

FIG. 7 is a schematic representation is a schematic representation of object and attribute strings and a database; and

FIG. 8 is a schematic illustration of a web-based user interface provided by the computer system.

### DETAILED DESCRIPTION

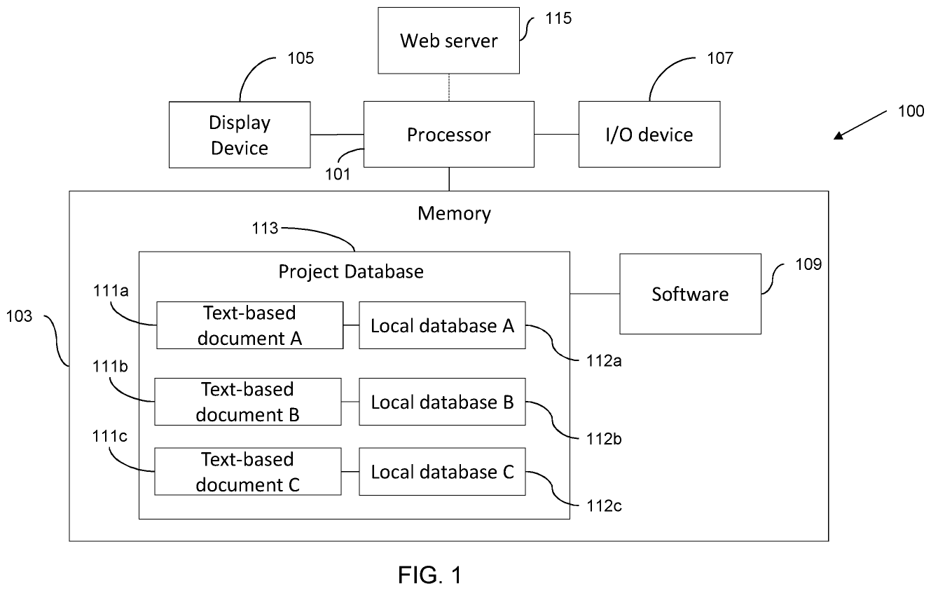

FIG. 1 shows a computer 100 for editing text-based documents. The computer 100 comprises a processor 101, a memory 103, a display device 105, and a user input/output device (I/O device) 107. The memory 103 may include RAM and/or a hard-drive or other non-volatile storage. The memory 103 stores instructions in the form of document-editing software 109, which can be executed by the processor 101 to allow one or more users to generate and edit text-based documents 111a-111c and associated local databases 112a-112c. The text-based documents 111a-111c and the associated local databases 112a-112c may be stored or indexed in a global database 113. They may be grouped into one or more projects each of which may contain multiple text-based documents. The global database 113 could be part of a file system, e.g. on a hard-drive, and/or may be stored in RAM when a project is opened for editing. The processor 101 is also connected to, or provides, a web server 115 to allow users access to data stored in the memory 113 through a web browser, which may be run locally on the same computer 100 or remotely over a network (e.g. over the Internet).

The text-based documents 111a-111c can be processed by the processor 101 of the computer 100 when executing the software 109 to display text content from an opened text-based document 111a-111c on the display device 105 and to allow the document 111a-111c to be modified by a user in response to inputs provided by the user at the I/O device 107, as will be described in the following.

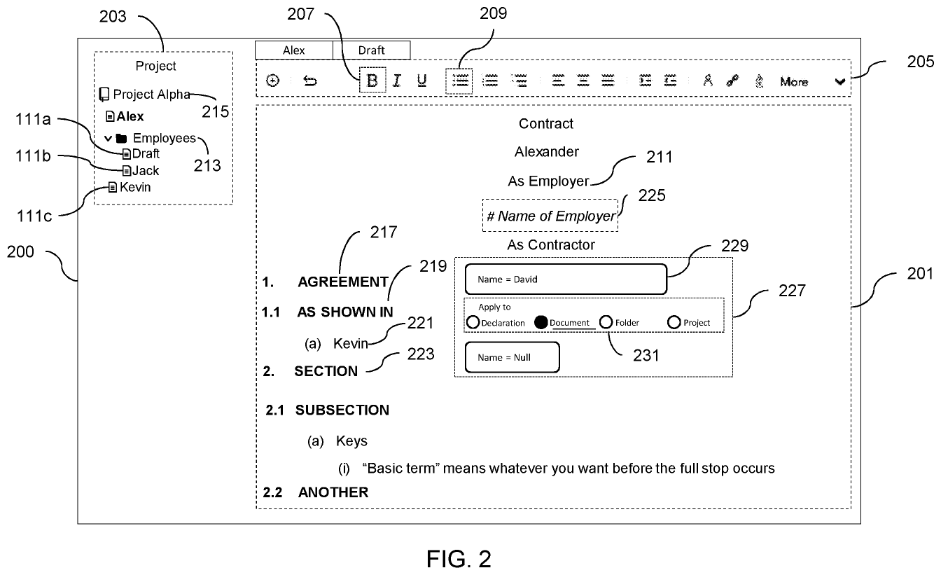

When executed by the processor 101, the software 109 is configured to display a graphical user interface (GUI) 200 on the display device 105. One example view is shown in FIG. 2. The graphical user interface 200 is configured to allow a user to generate and edit the text content of the text-based documents 111a-111c, and also to configure associated data, stored in the local databases 112a-112c and/or global database 113, that the software 109 uses to alter what is displayed to the user—e.g. to substitute some text content of the document with different text data.

The user interface 200 comprises a text editing pane 201, a project viewer pane 203, and a text editing toolbar 205 through which text-editing tools, such as text-formatting tools 207, and document layout tools 209 can be accessed by a user of the software 109 The text editing pane 201 is configured to display the content of one of the text-based documents, e.g. 111c, stored in the memory 103 of the computer 100. The text-based document 111c is displayed in the text editing pane 201 in the form of a plurality of text strings (e.g. the text string “Employer” 211 in FIG. 2), which may comprise sequences of one or more ASCII characters. All of the various text strings shown in the editing pane 201 of FIG. 2 are collectively text strings representing the currently-displayed content of the text-based document 111c.

To take the text string “Employer” 211 as a representative example, this string is editable in response to a user input provided at the text editing pane 201 through the I/O device 107. For example, the user may input a character string such as “Employer” by typing on a keyboard, causing text corresponding to said character string to appear in the editing pane 201. Text strings 211 can be displayed across a plurality of lines in the editing pane 201, which may be separated by the input of a line break character. The visual appearance of the text strings 211 shown in the editing pane 201 may be changed using the text-formatting tools 207, e.g. by applying bold, underline or italic formatting to the text 211, adjusting the spacing between lines of text 211, applying highlighting to the text 211, etc. The text-formatting tools may be applied by a user in response to the user clicking (i.e. using a mouse) or tapping (i.e. through a touch-based interface) the text-formatting tools 207, or through the use of predetermined inputs through an input device such as a keyboard.

The project viewer 203 of the user interface 200 is configured to display one or more text-based documents 111a-111c stored in the memory 103, including the text-based document 111c shown in the editing pane 201. The text-based documents 111a-111c shown in the project viewer 203 may be associated with (e.g. stored as files within) one or more folders, 213, which may be associated with (e.g. stored within) one or more projects 215, such that the text-based documents 111a-111c can be organised into a hierarchical structure for ease of use. These files and folders may represent actual files and folders in a file system (e.g. NTFS or FAT32) of a hard-drive of the memory 103, but this is not necessarily the case in all embodiments.

The software 109 is configured to automatically (i.e. without user input) determine the type of information represented by the text string 211 in the editing pane 201, and to apply appropriate formatting for ease of user reference when viewing the editing pane 201 through the display device 105. For example, if the text string 211 represents a numerical value, such as “525”, it may be displayed in a first colour in the editing pane 201, while if the text string 211 is a sequence of characters representing a word, e.g. “Employer” the text string 211 may be displayed in a second colour in the editing pane 201. The software 109 may also recognise that text string 211 represents a Boolean value, and display this using a third colour through the user interface 200. In this way, users of the software 109 may be able to easily distinguish between different data types present within the text-based document.

Text strings 211 may have associated structural properties within the text-based document 111c. These may be assigned by a user. For example, the text string 211 may be set as a “body text”, or as a “title”, “section heading”, “sub-section heading”, etc.

Structural properties of the text strings 211 may be set by a user, e.g. by selecting the text string 211 and applying one or more formatting operations using a document layout tool 207, or may be applied automatically (i.e. without user input) by the software 109 using a “smart numbering” functionality of the software 109. For example, if a user defines a first section 217, e.g. “1. AGREEMENT”, and subsequently enters a line break in the editing pane 201, the software 109 may determine that further sections or sub-sections are likely to follow, and provide suggested formatting to the user by automatically beginning a new first sub-section 219, e.g. “1.1 AS SHOWN IN” in response to the line break. The user may then enter text in the first sub-section 219. Additional levels of sectioning, such as a sub-section 221, e.g. “(a) Kevin”, or a second section 223, e.g. “2. SECTION”, as shown in FIG. 2, may be suggested in response to further input by the user, e.g. further line breaks being input in the editing pane 201 after sections/sub-sections have been defined.

After a structure such as a first section 217, or a first sub-section 219 has been included in the text-based document 111c, subsequent input of the first character(s) of an existing structure, e.g., “1.” elsewhere in the editing pane 201 may cause existing structure(s) within the text-based document 111 beginning with said first character(s) to be displayed to the user as suggested autocomplete values. For example, with reference to FIG. 2, if a user enters the string “1.” in the text editing pane 201 after section 217 has been defined, a list comprising the first section 217 and the first sub-section 219 may be displayed to the user as suggested autocomplete text strings, as the string of text associated with each structure begins “1.” . This allows a user to more readily reference existing structures within the text-based document 111c. For example, if a user wishes to refer to an earlier section (e.g. first section 217) in a later paragraph of text, the user may simply type “1.” and select the suggested autocomplete value provided by the software, rather than typing out the section title in its entirety. The full title of the first section 217 (i.e. “1. AGREEMENT”) can then be displayed in response to the user selection.

Formatting may be applied to the text 211 based on the structural properties of the text strings 211 within the text-based document 111c, e.g. titles, sections, sub-sections etc may be displayed in different colours/sizes in the text editing pane 201 to improve ease of user comprehension.

The software 109 allows a user to build (e.g. create, add to, and/or edit) one or more databases (which may be local databases 112a-112c, or entries within the global database 113) that are associated with the text-based documents 111a-111c. Users may do this using user inputs provided through the text editing pane 201.

Notably, users are able to define strings of text within the text editing pane 201 as “attribute strings” (also referred to herein as attributes) and to cause the software 109 to store respective “attribute string value” (also referred to herein as values) in a database linked to a text-based document 111a-111c, as will be described in the following. In some embodiments, these attributes may be further associated with objects and/or classes of objects, as described below.

Once a first instance of a text string is identified as an attribute string in a particular document 111c in the text-editing pane 201, further instances of the text string are also identified as instances of the attribute string 201, and their value can be modified throughout the entirety of the text-based document 111c (and optionally throughout other text-based documents in the same folder or project) by instructing the software 109 to set or amend the attribute string value associated with the attribute string in the database that is linked to the text-based document 111c (and optionally in databases of other text-based documents 111a and 111b within the same folder or project). The user may limit the identification of a text string as an attribute string to a specific text-based document 111c, or may instruct the software 109 to apply it across a folder 213 or project 215.

For example, a text-based document such as an employment contract may contain text strings corresponding to an employee and an employer, but may be reproduced for a plurality of employees across an organisation. Identification of attribute strings as descried above may thus be used to facilitate changes to such an employment contract across the organisation. Attribute strings within the contract may be identified for each of the terms “employee” and “employer”, but attribute string values may be assigned differently in each case. In particular, an attribute string value for the employee (e.g. the name of the employee) may be defined only within a specific instance of the employment contract, while an attribute string value for the employer (e.g. the name of the employer) may be defined for a folder containing the employment contracts of all employees. This allows employer information (i.e. the name of the employer) to be modified across all employment contracts (i.e. globally) by changing the attribute value in a single contract, causing the attribute value associated with the attribute string “employer” to be changed in a database associated with the folder in which the employment contracts are stored. This change in the database will then cause the modified employer name to be reproduced across all employment contracts in the folder. In this way, although the employee name may be unique to the employment contract, the employer name may the kept consistent across all employment contracts in an “employment contracts” folder, even following a change in name.

To identify a string as an attribute string, the user provides a predetermined input through the text editing pane 201, such as inserting a predetermined attribute-marker character string (of one or more characters) into the text-based document 111c adjacent the text string to be identified as an attribute string.

In the example GUI view shown in FIG. 2, in which a document representing a draft legal contract is being edited, the special attribute-marker character string is the character “#”, and this is used to identify the text string “Name” as an attribute string 225 by being inserted immediately before the string “Name” in the text editing pane 201. This insertion causes the software 109 to store the text string “Name” as an attribute in a database for the document, if it does not already exist.

The user can then input a value to be associated with the attribute string in the database, allowing the value of the attribute string displayed in the editing pane 201 of the text-based document 111c to be updated by changing the value of the attribute string stored in the database. The attribute string value can be input through a pop-up box 227 that is displayed within the editing pane 201 in response to the user clicking or selecting an attribute string in the displayed content of the document (i.e. a string that is prefixed by the “#” character). The pop-up box 227 includes a text-input field 229 in which the value of the attribute string can be typed by the user, e.g. in the form of a definition such as “attribute string”=“value”. In the example view shown in FIG. 2, a string value of “David” is thus assigned to the attribute string “Name” using the popup box 227. After being defined in this way, the attribute string “Name” can be replaced by “David” throughout the text-based document 111c.

In addition to changing the value of one single instance (i.e. one declaration) of the attribute string “Name” in the text-based document 111c, the value of the attribute string may also be replaced across the text-based document 111c, or across the folder 213 or project 215 with which the text-based document 111 is associated, based on a further user input. Specifically, the popup box 227 includes a selection pane 231 comprising a series of checkboxes-Declaration, Document, Folder, Project-that allow a user to select how broadly the string value is applied. The updated value of the attribute string “Name” may be applied to a single instance of the attribute string, or may be applied within the whole of the text-based document 111c being displayed in the editing pane 201. Alternatively, the string value may be applied to the attribute string in all text-based documents 111c stored within the same folder, or within the same project, as the text-based document 111c being displayed in the editing pane 201, depending on the selection provide by the user in the selection pane 231.

Although a pop-up box is used to provide a value for the attribute string 225 in the embodiment FIG. 2, this may also be achieved by providing an appropriate input in the text editing pane 201. For example, a user may provide the value of an attribute string using a predetermined command in the text, such as typing #“attribute string” =“attribute string value”.

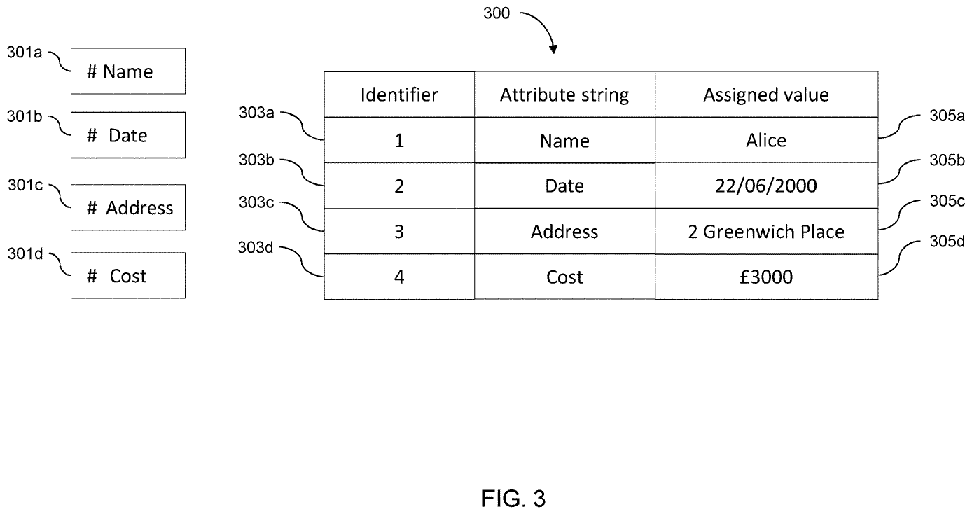

An example of a database of attribute strings that may be generated by the software 109 for an exemplary document is illustrated in FIG. 3.

FIG. 3 shows the identification of attribute strings 301a-301d in the text editing pane 201 from text strings using the attribute-marker character string “#”, and the associated entries in a database 300, which are updated in response to the attribute-marker character string “#” being provided before the attribute strings 301a-301d. For each attribute string 301a-301d, an entry is created in the database 300 with an associated identifier in the form of an attribute string number 303a-303d, accompanying the attribute string, and an assigned value 305a-305d, that can be input by the user after the attribute string is defined, e.g. using the pop-up box 227 shown in FIG. 2.

Attribute strings identified from a text-string in the document 111c in response to the attribute-marker character “#” can thus have a value assigned in response to a user input, i.e. a definition of the value of the attribute string.

The attribute string value assigned by the user may take the form of any string represented by one or more characters. For example, in FIG. 3, the attribute string 301a, identified from a text string “Name” has an assigned attribute string value 305a of “Alice”. The attribute string 301b, identified from a text string “Date” has an assigned attribute string value 305b of “22/06/2000”. The attribute string 301c, identified from a text string “Address” has an assigned attribute string value 305b of “2 Greenwich Place”. The attribute string 301d, identified from a text string “Cost” has an assigned attribute string value 305b of “£3000”.

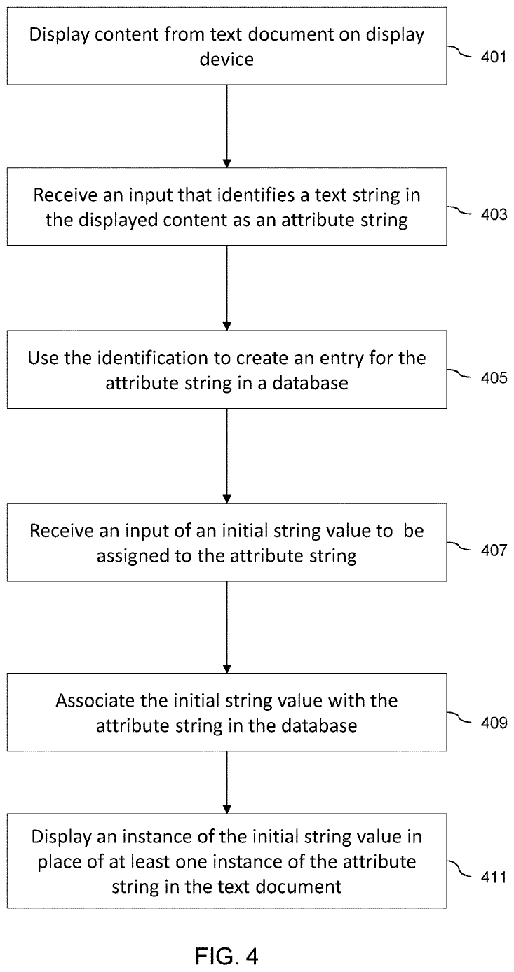

Once an attribute string value 305 has been assigned to an attribute string in the database 300, the attribute string value 305 can be displayed in the editing pane 201 in place of the initial text string throughout the text-based document 111c. For example, if the text string “Name” is present multiple times in the document 111c, identification of the text string “Name” as an attribute string, and the assignment of an attribute value of “Alice” to the attribute string would replace the string “Name” with the string “Alice” throughout the text-based document 111c. This process is illustrated in FIG. 4.

FIG. 4 is a flow diagram illustrating the process of building a database of attribute string values from text strings in a text-based document 111c using the software 109 and the subsequent update of the values of the attribute string within the text-based document 111c using a database as shown in FIG. 3.

In a first step 401, the content of the text-based document 111c is displayed on the display device 105, such that the text-based document 111c can be edited by a user through the text editing pane 201 of the user interface 200 by providing inputs at the input/output device 107.

In a second step 403, an input is received from the user in the text editing pane 201 through the input/output device 107 that identifies a text string in the displayed content of the text-based document 111c as an attribute string.

In a third step 405, an entry for the attribute string is created in a database associated with the text-based document 111c based on the identification of the attribute string in the text-based document 111c.

In a fourth step 407, an input is received from a user through the input/output device 107 that provides an initial attribute string value to be assigned to the attribute string. In a fifth step 409, the initial string value is associated with the attribute string in the database.

In a final step 411, an instance of the initial string value in the text-based document 111 is displayed in place one or all instances of the attribute string in the document 111c (and optionally across a whole folder/project in which it is stored) when the text-based document 111 (and optionally any other document from the same folder/project) is displayed the display device 105.

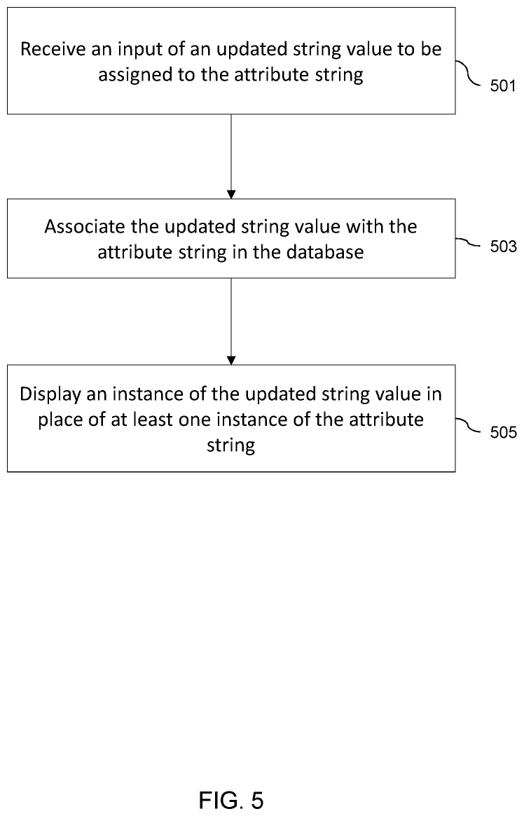

After it has initially been replaced, the attribute string within the underlying text content of the text-based document 111c (or the folder/project in which it is stored) may be further updated by setting an updated the attribute string value stored in the database. An example of this process is shown in FIG. 5.

In step 501 an input is received from a user in the text editing pane 201 through the input/output device 107 that provides an updated string value to be assigned to the attribute string stored in the database.

In step 503, the attribute string in the database is associated with the updated attribute string value in response to the user input.

In step 505, an instance of the updated attribute string value in the text-based document 111 is displayed in place of an instance of the attribute string in the editing pane 201 of the user interface 200, and is displayed to the user at the display device 105.

This allows text strings in the text-based document identified as attribute strings to be updated throughout the text-based document 111 (or the folder/project in which it is stored) by updating the attribute value in the database.

The attribute strings described above in relation to FIGS. 1 to 5 are identified in relation to a single text string, and no functional link is present between attribute values stored in a database. However, in some embodiments, attribute strings may be optionally linked via an association with “object strings” within the text content of document that may be identified and defined in the editing pane 201 of the user interface 200.

Object strings may be used to group two or more attribute strings together, e.g. to define an object of class of object within the text-based document 111c having properties in the form of a plurality of attribute strings, where the properties are defined by attribute string values. For example, the text string “Employer” may be identified as an object string, and may be associated by the user with attribute strings “Name” and “Address”. These may then be given attribute string values corresponding to the actual name and address of a particular employer.

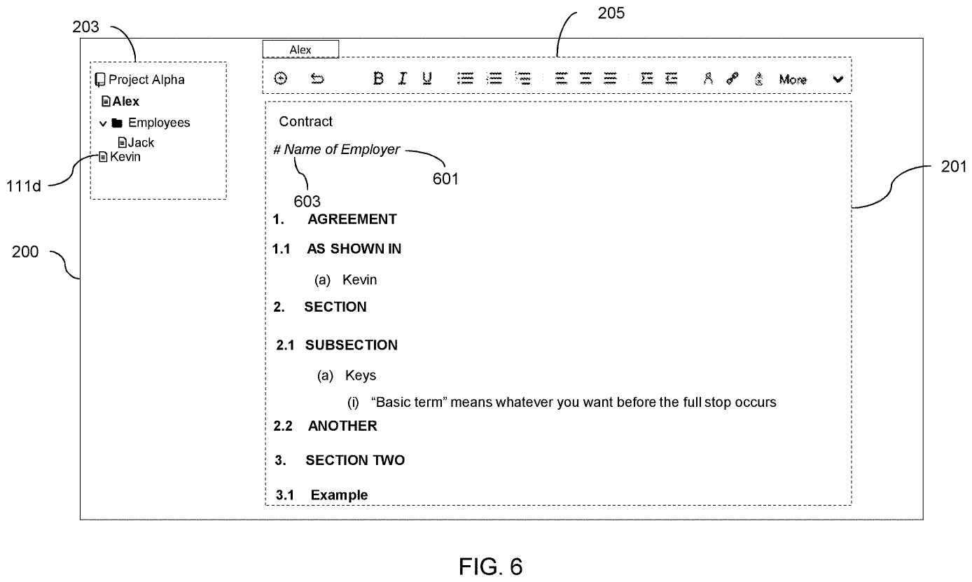

A user may identify a first text string in the text-based document 111c as an object string, and identify one or more further text strings in the text-based document 111 as an attribute string associated with the object string. An example of this is shown in FIG. 6.

FIG. 6 shows the user interface 200 illustrated in FIG. 2, displaying a different text-based document 111d in the editing pane 201 in which an object is identified as described in the following. To identify a text string in the text-based document 111d as an object string, the user provides a predetermined input, comprising a predetermined object-marker character string (of one or more characters) to the text-based document 111d adjacent the text string to be identified as an object string.

In the embodiment shown in FIG. 6, the object-marker character string takes the form of the phrase “#xx of” where “xx” can be any text string, and is used to identify an attribute string to be associated with the object string, and where the string immediately after the word “of” is identified as an object string. The character “#” thus serves the same role of identifying a string that follows “#” as an attribute string, while the term “of” serves both to identify the string that follows “of” as an object, and to identify the attribute string preceding “of” as an attribute string associated with the object string. Multiple attribute strings may thus be identified for the same object, using two or more statements in the form of “#attribute of object”, e.g. by including the text “#Name of Employer” and “#Address of Employer” within the text-based document 111c.

In the example shown in FIG. 6 therefore, the string “Employer” is identified as an object string 601, while the string “Name” is identified as an attribute string 603, associated with the object string 601. The value of attribute strings 601 defined in this way is initially set to null or zero, but a value may be assigned to the attribute string in the same way as described in relation to FIGS. 2 to 6 (e.g. using a pop-up box or an in-line definition). The object string also has a value (i.e. an identifier) that can be defined in the same manner.

The identification of the object string 601 and the attribute string 603 using the object-marker character string causes an entry associated with the text string “Employer” to be stored in a database as an object string, and causes an entry associated with the text string “Name” to be stored in a database as an attribute string, associated with the object string.

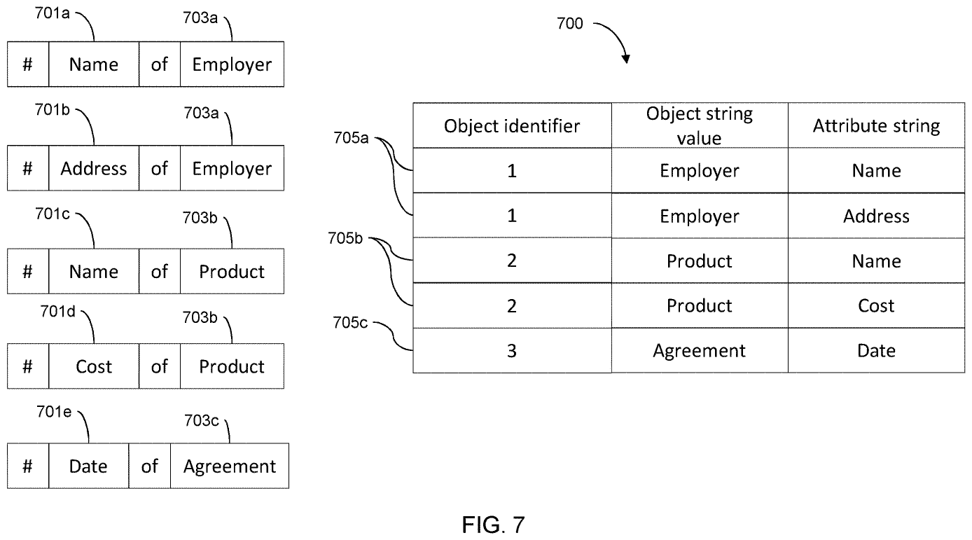

An example of a database structure created in this way is shown in FIG. 7. In the example shown in FIG. 7, five attribute strings 701a-701e, and three object strings 703a, 703b and 703c, with which the attribute strings 701a-701 are associated, are identified as described in relation to FIG. 6. Specifically, a first object string 703a (“Employer”) is identified in a text-based document with two associated attribute strings 701a, 701b (“Name” and “Address” respectively). A second object string 703b (“Product”) is also identified and has two associated attribute strings 701c, 701d (“Name” and “Cost” respectively). Finally, a third object string 703c (“Agreement”) is identified having a single associated attribute string 701e (“Date”).

The object strings 703a-703c and the attribute strings 701a-701e are stored in a database 700 as shown in FIG. 7. For each attribute string 703a-703c, an entry is created in the database 700 with an associated identifier in the form of an object string number 705-705c, associated with each object string 703a-703c, and associated attribute strings 701a-701e, are stored in the database 700, linked with the object identifiers 705a-705c. The attribute strings 701a-701e associated with each object string 703a-703c may have attribute string values assigned as described in relation to FIGS. 2 to 6. The value of the identifier associated with each object string may also be changed in the same way.

The object strings 703a may have any number of associated attribute strings 701a-701e, which may take the form of a variety of data types. After a value has been assigned to an attribute string by a user, the software 109 may determine that the attribute string 701a-701e has a particular data type. For example, the software 109 may render a determination that an object string or an attribute string is a date (e.g. a set date, date range, or the date of entry in the database 700), a time (e.g. a set time, a timespan, or the time of entry in the database 700), a number (e.g. an integer or decimal), a monetary value, (e.g. an integer or decimal in combination with a currency identifier such as “£”), a location (e.g. an address, city, or country), an outline structure (e.g. a first, second or third level etc.), a lists (e.g. a numbered list, bullet point, checklist), a “block” (e.g. a picture, table, code block, quote block, or mathematical formula), or a “tag” (e.g. a person, organisation, team or group).

Once object strings, e.g. 703a-703c have been identified within a text-based document 111, associations between two or more of these object strings can be defined. For example, an object string may be representative of a person, and have associated attribute strings corresponding to the name and address of that person. An object string may alternatively be representative of an employee, and have associated attribute strings corresponding to salary and a role. An association can thus be set up, e.g. an employee may be defined as a person, such that any object string identified as an employee will automatically also have associated attribute strings corresponding to the attribute strings linked to the “person” object string. Thus, if an association is established between the “person” and “employee” object strings, all employee object strings will have attribute strings corresponding to each of a name, address, role and salary.

As well as generating class associations between multiple object strings, interactions between attribute strings of objects (which may be in different classes) can be established through relational links. These may be used to cause the software to automatically update the values of multiple attributes in response to a user updating the value of just one attribute. They can support arithmetic operations and logical operations. For example, an “Employee” object may have a first attribute, “Salary”, and a second attribute, “Bonus”, both of which have string values corresponding to numerical values. In order to determine the amount that the employee should be paid to account for both their salary and bonus payment, a new attribute associated with the “Employee” object may be generated using the existing attribute values. This may be achieved by defining a new attribute “Pay” as having a value “Pay of Employee =Salary of Employee +Bonus of Employee”. Advantageously, this new attribute may be generated entirely using in-line text within the text-based document. If the value of the attribute “Salary” changes at a later date, the value of the new attribute “Pay”, which is dependent on the value of the attribute “Salary” is dynamically updated by the software. In this way, dynamic interactions between attributes may ensure that information within the text-based document remains consistent, even after the value of one or more attributes is updated.

The values of these attribute strings can be input directly into the editing pane 201 of the user interface by the user as described in relation to FIGS. 1 to 6, or may be input using a web-based user interface, accessible via the web server 115 of the computer 100, in which data is visible in an editable table format.

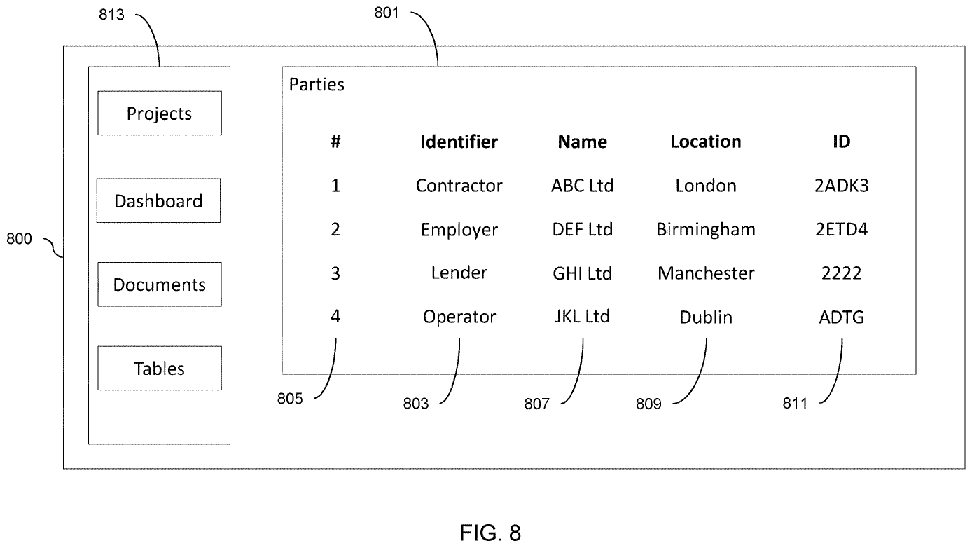

An example of such a web-based user interface is illustrated in FIG. 8.

FIG. 8 shows a web-based user interface 800, accessible via the computer system 100. The graphical user interface 800 is configured to allow a user to edit the values of object strings and attribute strings associated with text-based documents, which may be text-based documents 111a-111c stored locally on the computer 100, or may be other text-based documents stored in a network.

The user interface 800 comprises a table 801 that shows object strings 803 of one or more text-based documents, in addition to respective object string numbers 805, and the attribute strings 807, 809, 811 associated with each object string 803.

The user interface 800 also comprises a project viewer 813, through which a user can select text-based documents, folders or projects in order to view and edit tables of object and attribute values of the selected text-based document, folder or project.

The table 801 shown in FIG. 8 shows four object strings 803: “Contractor”, “Employer”, “Lender”, and “Operator”, each having three associated attribute strings 807 (“Name”), 809 (“Location”) and 811 (“ID”). Although the object strings 803 have common attribute strings, the attribute strings 807, 809, 811 associated with each object string have different attribute string values. Thus, while the object string “Contractor” and “Employer” both have an attribute “Location”, the value of this attribute string is different for each object, being “London” and “Birmingham” respectively.

The values of the attribute strings 807, 809, 811 can be modified by a user by changing the attribute string values stored in the table 801, e.g. by providing an input through the user interface 800 using the I/O device 107 of the computing device 800. Once an attribute string value in the table 801 is modified, the attribute string value of the attribute strings in the text-based documents with which the table 801 is associated can be updated accordingly in response. Thus, the web-based user interface 800 can be used to update the values of object and/or attribute strings across a plurality of text-based documents, folders, or projects, which are not required to be stored in a memory 103 of the computer 100.

In some embodiments, the software 109 supports dynamic version control that allows a user to commit the latest state of a project, along with all its document files, folders and annotations, to a selected branch in a distributed network that keeps track of a history trail of the file or files, without having to save multiple versions of the same document. A user can create different branches and assign access privileges to any user or group of users. For example, an internal branch might allow multiple colleagues all to work on an initial version of a work product. Then, once the document or project is finalized, it may be committed to a “client” branch for review and approval by a client. Once approved by the client, a third branch could enable reviewers or other third parties to access the final version, to review it and possibly make changes to it based on granted permissions.

It will be appreciated by those skilled in the art that the invention has been illustrated by describing one or more specific embodiments thereof, but is not limited to these embodiments; many variations and modifications are possible, within the scope of the accompanying claims.

1. A method for editing a text-based document, wherein the method is performed by a computer system and comprises:
causing content from a text-based document to be displayed on a display device;
causing a user interface for editing the document to be provided on the display device;
processing an input that identifies a text string in the document as an attribute string;
creating an entry for the attribute string in a database;
receiving, through the user interface, an initial string value to be assigned to the attribute string;
associating the initial string value with the attribute string in the database; and
causing content from the document to be displayed on the display device, wherein an instance of the initial string value is displayed in place of an instance of the attribute string in the document.

2. The method of claim 1, further comprising:
receiving, through the user interface, an updated string value to be assigned to the attribute string, wherein the updated string value is different from the initial string value;
associating the updated string value with the attribute string in the database; and
causing content from the document to be displayed on the display device, wherein an instance of the updated string value is displayed in place of an instance of the attribute string in the document.

3. The method of claim 1, comprising causing a respective instance of the initial string value to be displayed in place of each of a plurality of instances of the attribute string in the document, when displaying content from the document on the display device.

4. The method of claim 1, comprising causing a respective instance of the initial string value to be displayed in place of each of a set of instances of the attribute string in the document that are all associated with a same object string in the database, when displaying content from the document on the display device.

5. The method of claim 1, comprising replacing the initial string value by the updated string value in the database.

6. The method of claim 1, wherein the input that identifies the text string as an attribute string comprises a predetermined attribute-marker character string

7. The method of claim 6, wherein the predetermined attribute-marker character string is an opening attribute-marker character string immediately before the attribute string.

8. The method of claim 1, comprising:
processing an input that identifies a text string in the document as an object string; and
associating one or more attribute strings with the object string in the database.

9. The method of claim 8, wherein the input that identifies the text string as an object string comprises a predetermined opening object-marker character string immediately before the object string.

10. The method of claim 1, further comprising:
processing an input that identifies a second text string in the document as a second object string;
receiving a command from a user to link the first object string with the second object string; and
for each of the one or more attribute strings that are associated with the object string in the database, additionally associating the respective attribute string with the second object string in the database.

11. The method of claim 1, wherein receiving the initial string value to be assigned to the attribute string comprises:
displaying a text input interface on the display device in response to a user interaction;
and receiving the user input of the initial string value into the text input interface element.

12. The method of claim 11, wherein the text input interface is displayed in response to a user interaction with an instance of an object string in the displayed content, and wherein the text input interface is configured to receive a number of string values equal to at least a number of attribute strings that are associated with the object string in the database.

13. The method of claim 11, wherein the text input interface is displayed in response to a user interaction with an instance of an object string in the displayed content, and wherein the text input interface provides an interface for defining a new attribute string to be associated with the object string in the database.

14. The method of claim 1, wherein the entry for the attribute string in the database is associated with a scope parameter in the database, and wherein the scope parameter determines whether an instance of the initial string value assigned to the attribute string is displayed in place of a single instance of the attribute string in the document or in place of every instance of the attribute string in the document.

15. A non-transitory computer-readable storage medium storing computer software for editing a text-based document wherein the computer software comprises instructions which, when executed by a computer system, cause the computer system to:
cause content from a text-based document to be displayed on a display device;
cause a user interface for editing the document to be provided on the display device;
process an input that identifies a text string in the document as an attribute string;
create an entry for the attribute string in a database;
receive, through the user interface, an initial string value to be assigned to the attribute string;
associate the initial string value with the attribute string in the database; and
cause content from the document to be displayed on the display device, wherein an instance of the initial string value is displayed in place of an instance of the attribute string in the document.

16. A computer system for editing a text-based document, wherein the computer system comprises a memory and a processing system, and is configured to:
cause content from a text-based document to be displayed on a display device;
cause a user interface for editing the document to be provided on the display device;
process an input that identifies a text string in the document as an attribute string;
create an entry for the attribute string in a database;
receive, through the user interface, an initial string value to be assigned to the attribute string;
associate the initial string value with the attribute string in the database; and
cause content from the document to be displayed on the display device, wherein an instance of the initial string value is displayed in place of an instance of the attribute string in the document.

17. The non-transitory computer-readable storage medium of claim 15, wherein the computer software further comprises instructions for:
receiving, through the user interface, an updated string value to be assigned to the attribute string, wherein the updated string value is different from the initial string value;
associating the updated string value with the attribute string in the database; and
causing content from the document to be displayed on the display device, wherein an instance of the updated string value is displayed in place of an instance of the attribute string in the document.

18. The non-transitory computer-readable storage medium of claim 15, wherein the computer software further comprises instructions for causing a respective instance of the initial string value to be displayed in place of each of a plurality of instances of the attribute string in the document, when displaying content from the document on the display device.

19. The non-transitory computer-readable storage medium of claim 15, wherein the computer software further comprises instructions for causing a respective instance of the initial string value to be displayed in place of each of a set of instances of the attribute string in the document that are all associated with a same object string in the database, when displaying content from the document on the display device.

20. The non-transitory computer-readable storage medium of claim 15, wherein the computer software further comprises instructions for replacing the initial string value by the updated string value in the database.
